(19) United States
(12) Patent Application Publication
(10) Pub. No.: US 2008/0223509 A1
(43) Pub. Date: Sep. 18, 2008

(54) ADHESIVE FILM AND METHOD OF FABRICATING FLEXIBLE DISPLAY USING THE SAME

(76) Inventors: Gi Heon KIM, Daejeon (KR); Yong Hae KIM, Gyeonggi-do (KR); In Kyu YOU, Daejeon (KR); Kyu Ha BAEK, Daejeon (KR); Seung Youl KANG, Daejeon (KR); Seong Deok AHN, Daejeon (KR); Kyung Soo SUH, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/129,848

(22) Filed: May 30, 2008

Related U.S. Application Data
(62) Division of application No. 11/477,066, filed on Jun. 28, 2006.

(30) Foreign Application Priority Data
Nov. 22, 2005 (KR) 10-2005-0111800

(51) Int. Cl. B32B 38/10

(52) U.S. Cl. 156/168

(57) ABSTRACT

An adhesive film and a method of fabricating a flexible display using the same are provided. The adhesive film includes: a support including a first surface disposed opposite to a flexible substrate for forming an image display element and a second surface disposed opposite to a support substrate for supporting the flexible substrate; a first adhesive material applied on the first surface of the support; and a second adhesive material applied on the second surface of the support and having a greater adhesive strength than the first adhesive material. The flexible substrate can be easily detached from the support substrate, so that the flexible display can be realized in various sizes and thicknesses using existing equipment without modification of mass-production equipment for realizing the flexible display.

### CROSS-REFERENCE TO RELATED APPLICATION

This application claims priority to and the benefit of Korean Patent Application No. 2005-111800, filed Nov. 22, 2005, the disclosure of which is incorporated herein by reference in its entirety.

### BACKGROUND

1. Field of the Invention

The present invention relates to a method of fabricating a flexible display, and more particularly, to an adhesive film and a method of fabricating a flexible display using the same which enable a flexible substrate to be easily detached from a support substrate for preventing flexing of the flexible substrate.

2. Discussion of Related Art

As modern industrial society evolves into a highly information-oriented society, the importance of the display industry, which enables visualization of various types of information obtained from various devices, is increasing. Moreover, this trend is expected to continue for some time. As the information revolution progresses, demand for information increases, and in the field of displays, man-machine interfaces for information delivery, research aimed at satisfying the human sense of sight and expressing the true colors and the intricacy of nature without regard to time or place is actively progressing.

In general, displays have been widely employed in TVs, monitors and mobile phones. However, as technology develops, there is increasing demand for displays that are lightweight and have a wide display area, superior resolution, and a fast display speed.

In response to such demand, efforts to enlarge a display device and reduce the density and thickness of a glass substrate of the display device have been stepped up. However, such efforts cause problems in ensuring processability and reliability, and thus a technological limit is confronted. An additional problem is that downsizing of display devices for portability clashes with consumers' desire for full-sized displays. Thus, in order to simultaneously obtain superior flexibility, lightweight, and portability, a need has arisen for a flexible display in which interconnections and elements of the display are formed on a flexible substrate.

A flexible display is typically made by disposing an image display element on a flexible substrate. There is a problem in that, because of its flexibility, the flexible substrate cannot be processed by conventional semiconductor manufacturing equipment or display manufacturing equipment for liquid crystal displays and e-paper etc. So, it is necessary to either develop special equipment or drastically modify conventional manufacturing equipment. Existing display set providers such as Sharp and Phillips have invented a chuck for a flexible display and applied it to a conventional manufacturing process. However, this method leads to difficulties in mass-production and processing.

### SUMMARY OF THE INVENTION

The present invention is directed to an adhesive film designed to enable easy detachment of a flexible substrate from a support substrate for preventing flexing of the flexible substrate in order to ensure processability and mass-producibility in flexible display fabrication.

The present invention is also directed to a method of fabricating a flexible display using the adhesive film.

A first aspect of the present invention provides an adhesive film comprising: a support including a first surface disposed opposite to a flexible substrate for forming an image display element and a second surface disposed opposite to a support substrate for supporting the flexible substrate; a first adhesive material applied on the first surface of the support; and a second adhesive material applied on the second surface of the support and having a greater adhesive strength than the first adhesive material.

A second aspect of the present invention provides a method of fabricating a flexible display comprising the steps of: preparing an adhesive film having a first adhesive material applied on a first surface disposed opposite to a flexible substrate and a second adhesive film applied on a second surface disposed opposite to a support substrate, the first and second adhesive materials having different adhesive strengths; depositing the adhesive film on the support substrate; depositing the flexible substrate on the adhesive film; forming an image display element on the flexible substrate; and detaching the flexible substrate from the adhesive film.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a cross-sectional view of an adhesive film according to a first exemplary embodiment of the present invention;

FIG. 2 is a flowchart illustrating a method of fabricating a flexible display using an adhesive film according to a second exemplary embodiment of the present invention; and

FIGS. 3A to 3C are cross-sectional views illustrating a method of fabricating a flexible display according to the second exemplary embodiment of the present invention.

### DETAILED DESCRIPTION OF EXEMPLARY EMBODIMENTS

The present invention will now be described more fully hereinafter with reference to the accompanying drawings, in which exemplary embodiments of the invention are shown. These exemplary embodiments are provided so that this disclosure will be thorough and complete. In the drawings, the thickness and length of layers and regions may be exaggerated for clarity. Like elements are denoted by like reference numerals throughout the drawings. Matters related to the present invention and well known in the art will not be described in detail when deemed that such description would detract from the clarity and concision on the disclosure.

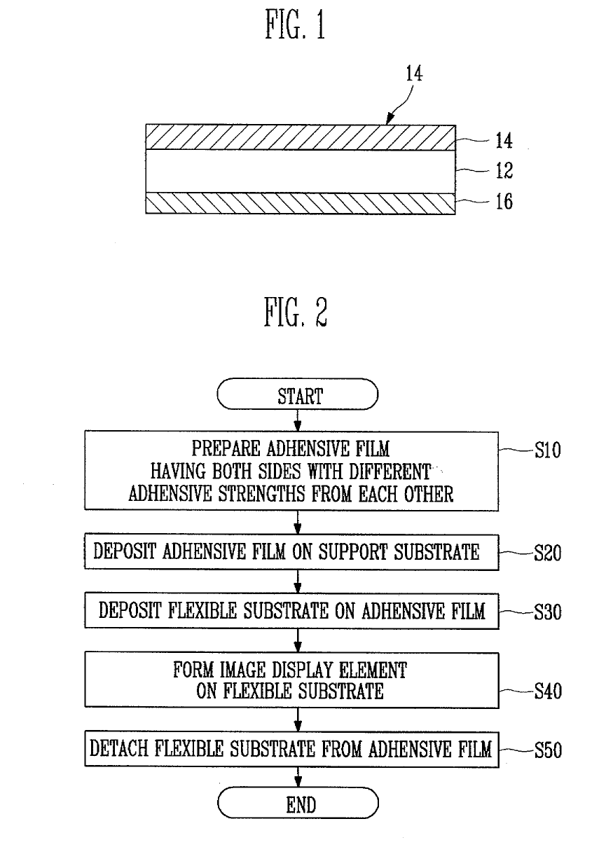

FIG. 1 is a cross-sectional view of an adhesive film according to a first exemplary embodiment of the present invention.

Referring to FIG. 1, an adhesive film 10 serves to fix a flexible substrate on a support substrate in order to improve processability and mass-producibility of a flexible display, and to dispose an image display element on the flexible substrate and then easily detach the flexible substrate from the support substrate. The adhesive film 10 includes a support 12 and first and second adhesive materials 14 and 16 applied on both surfaces of the support 12 and having different adhesive strengths.

The support 12 is for supporting the first and second adhesive materials 14 and 16, and may be formed by one selected from the group consisting of polyethylene terephthalate, polybutylene terephthalate, polyimide, polyester, polyethylene and polypropylene.

The first adhesive material 14 is applied on a first surface of the support 12 facing the flexible substrate. The first adhesive material 14 may have an adhesive strength of 0.1 to 20 N/100 mm, and preferably, 0.2 to 6 N/100 mm. The second adhesive material 16 is applied on a second surface of the support 12 facing the flexible substrate, and may have an adhesive strength of 10 to 40 N/100 mm, and preferably, 16 to 30 N/100 mm. Also, the first and second adhesive materials 14 and 16 may be an acrylate- or silicon-based adhesive agent. The aforementioned first and second adhesive materials 14 and 16 may be embodied as different kinds of adhesive agents having different adhesive strengths, or the same kind (material) of adhesive agent adjusted to have different adhesive strengths.

The flexible substrate may be a metal foil, a thin glass substrate or a plastic substrate, and the support substrate may be a glass substrate or a silicon substrate. Also, in FIG. 1, each layer is drawn to be easily recognizable, and the actual thicknesses of the layers may be different.

In the above structure, the flexible substrate is closely adhered to the support substrate by the adhesive film 10 to prevent flexing during a display manufacturing process, and to enable easy detachment from the adhesive film 10 after forming an image display element.

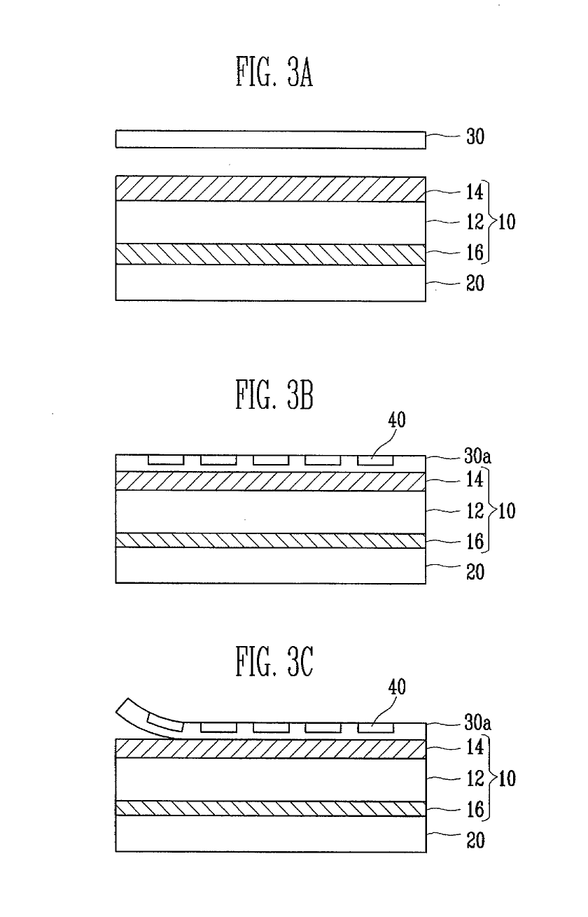

FIG. 2 is a flowchart illustrating a method of fabricating a flexible display using an adhesive film according to a second exemplary embodiment of the present invention. In addition, FIGS. 3A to 3C are cross-sectional views illustrating a method of fabricating a flexible display according to a second exemplary embodiment of the present invention.

Referring to FIG. 2 as a basic figure, a method of fabricating a flexible display according to the present invention includes preparing an adhesive film having both sides with different adhesive strengths from each other (S10). Next, the prepared adhesive film is deposited on a support substrate (S20). Then, a flexible substrate is deposited on the adhesive film (S30).

An adhesive film 10, as described in FIG. 3A, is composed of a support 12, and first and second adhesive materials 14 and 16 applied on both surfaces of the support 12. The adhesive film 10 is deposited on a support substrate 20 and under a flexible substrate 30. But, in FIG. 3A, the flexible substrate 30 is not yet deposited on the adhesive film 10.

Next, an image display element is formed on the flexible substrate (S40). In this step, as shown in FIG. 3B, an image display element 40 is formed on the flexible substrate, thereby defining the flexible substrate as a thin film transistor substrate or a color filter substrate represented by reference numeral 30a.

Specifically, the thin film transistor substrate includes the image display element having a plurality of thin film transistors for image display, and the color filter substrate includes the image display element having a color pixel layer. The thin film transistor includes at least one of an organic thin film transistor, an amorphous thin film transistor and a polycrystalline thin film transistor.

Then, the flexible substrate is detached from the adhesive film (S50). In the step, the flexible substrate 30a can be easily detached from the adhesive film 10 in a physical or mechanical way, because the first adhesive material having a lower adhesive strength than the second adhesive material adhered closely to the support substrate 20 is deposited on the adhesive film 10, as shown in FIG. 3C.

### EMBODIMENTS

In the present invention, adhesive strength, thermal resistance and chemical resistance of the adhesive film are important factors exerting a direct influence on process stability and reliability of the flexible display. Table 1 shows a stacked structure and process properties of the flexible substrate according to an exemplary embodiment of the invention.

TABLE 1

| | Adhesive strength | | | | | | | |
|---|---|---|---|---|---|---|---|---|
| | (N/100 mm) | | Component of adhesive film | | | | | |
| | Second | First | Second | | First | | | |
| | adhesive | adhesive | adhesive | | adhesive | Thermal | Chemical | Detach- |
| TYPE | material | material | material | Support | material | resistance | resistance | ability |
| 1 | 24 | 24 | Silicon- | Polyimide | Silicon- | ∘∘ | ∘∘ | xx |
| | | | based | | based | | | |
| 2 | 30 | 18 | | Polyester | | x | | xx |
| 3 | 30 | 6 | | | | x | | ∘∘ |
| 4 | 32 | 0.2 | | | | xx | | |
| 5 | 29 | 2.3 | | Polyimide | | ∘∘ | | |
| 6 | 16 | 5 | Acryl- | Polyester | Acryl- | ∘ | xx | ∘∘ |
| | | | based | | based | | | |

As can be seen from Table 1, in consideration of process stability and reliability, the flexible substrate having the image display element was easily detached from the adhesive film/support substrate when the second adhesive material adhered to the support substrate had an adhesive strength of at least 16 to 30 N/100 mm, and the first adhesive material adhered to the flexible substrate had an adhesive strength of at least 0.2 to 6 N/100 mm. Also, it can be seen that it was proper to form the adhesive material of the adhesive film of a silicon-based adhesive agent, and proper to form the support supporting the adhesive material of polyimide having superior thermal and chemical resistance.

In the embodiment, the support substrate was a 0.7 mm glass substrate, and the flexible substrate was a polycarbonate plastic substrate having a thickness of 125 μm. The adhesive strength was defined as peel strength (N/100 mm) by a ASTM 3350 measurement method, and the chemical resistance was measured by observing adhesive film damage with an optical microscope after the adhesive film was dipped in a solvent (IPA, acetone, water, PR developer, PR remover, metal etchant, etc.) used in a semiconductor process for 10 minutes and then dried.

The symbol ◯◯ means no chemical damage occurred, and the symbol xx means chemical damage occurred throughout the adhesive film. The thermal resistance was defined by thermally treating the adhesive film for 2 hours at 150° C., and determining whether out-gas came out from the adhesive film between the adhesive film and the support (glass or plastic substrate), or whether an adhesive material layer of the adhesive film was chemically degenerated by heat, thereby changing its adhesive strength. Here, the symbol ◯◯ means there was no out-gas from the adhesive film by heat and no chemical degeneration of the adhesive material layer, and the symbol xx means there was out-gas from the adhesive film by heat or the outstanding chemical degeneration of the adhesive material layer. Detachability was defined by the easiness of a detaching process and damage to the image display element formed on the flexible substrate when the flexible substrate was physically, mechanically detached from the adhesive film. The symbol ◯◯ means the image display element was isolated without damage, whereas the symbol xx means the opposite case.

As the result of the exemplary embodiment, it can be deduced that if the strength of the adhesive material applied on both sides of the support was designed differently in consideration of the process and separation of the display, that is, if the strength of the adhesive material adhered to the support substrate was designed to have a greater value than that of the adhesive material adhered to the flexible substrate, the flexible substrate is easily detached.

As described above, an adhesive film according to the present invention can offset stress generated by a difference in coefficients of thermal expansion between a flexible substrate and a support substrate in a high-temperature (150-250° C.) process of forming an image display element on a flexible substrate such as a plastic substrate, thereby effectively dealing with the flexibility of the flexible substrate and enabling easy detachment of the flexible substrate after formation of an image display element. Moreover, processability and mass-producibility of a flexible display can be improved. Also, a method of fabricating a flexible display using the adhesive film according to the present invention enables mass-production of flexible displays without additional investment in manufacturing equipment, because a conventional manufacturing line for semiconductors and displays can be applied to the invention without equipment modification.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of fabricating a flexible display, comprising the steps of:
(a) preparing an adhesive film having a first adhesive material applied on a first surface disposed opposite to a flexible substrate and a second adhesive film applied on a second surface disposed opposite to a support substrate, the first and second adhesive materials having different adhesive strengths;
(b) depositing the adhesive film on the support substrate;
(c) depositing the flexible substrate on the adhesive film;
(d) forming an image display element on the flexible substrate; and
(e) detaching the flexible substrate from the adhesive film.

2. The method of fabricating a flexible display according to claim 1, wherein step (a) includes the step of preparing an adhesive film on which the second adhesive material closely adhered to the support substrate has a greater adhesive strength than the first adhesive material closely adhered to the flexible substrate.

3. The method of fabricating a flexible display according to claim 2, wherein the first adhesive material has an adhesive strength of 0.1 to 20 N/100 mm, and the second adhesive material has an adhesive strength of 10 to 40 N/100 mm.

4. The method of fabricating a flexible display according to claim 1, wherein the image display element includes a thin film transistor, and the flexible substrate is defined as the thin film transistor substrate by step (d).

5. The method of fabricating a flexible display according to claim 4, wherein the thin film transistor includes at least one of an organic thin film transistor, an amorphous thin film transistor and a polycrystalline thin film transistor.

6. The method of fabricating a flexible display according to claim 1, wherein the image display element includes a color pixel layer, and the flexible substrate is defined as a color filter by step (d).

7. The method of fabricating a flexible display according to claim 1, wherein the first and second adhesive materials includes an acrylate-based adhesive agent or a silicon-based adhesive agent.

8. The method of fabricating a flexible display according to claim 1, wherein the adhesive film includes one selected from the group consisting of polyethylene terephthalate, polybutylene terephthalate, polyimide, polyester and polyolefin.

9. The method of fabricating a flexible display according to claim 1, wherein the flexible substrate includes one selected from the group consisting of a metal foil, a thin glass substrate and a plastic substrate.

10. The method of fabricating a flexible display according to claim 1, wherein the support substrate is a glass substrate or a silicon substrate.
